(19) United States
(12) Patent Application Publication
(10) Pub. No.: US 2016/0339835 A1
(43) Pub. Date: Nov. 24, 2016

(54) METHOD FOR CONTROLLING A VEHICLE HEADLAMP SYSTEM

(71) Applicant: FORD GLOBAL TECHNOLOGIES, LLC, Dearborn, MI (US)

(72) Inventors: Marc ROEBER, Duesseldorf (DE); Gerald DOERNE, Cologne (DE); Kristian ZARSE, Cologne (DE); Frank AUST, Neuss (DE)

(21) Appl. No.: 15/160,839

(22) Filed: May 20, 2016

(30) Foreign Application Priority Data
May 22, 2015 (DE) 10 2015 209 419.7

(51) Int. Cl. B60Q 1/14; B60Q 1/16

(52) U.S. Cl. CPC B60Q 1/14; B60Q 1/16; B60Q 2300/056; B60Q 2300/42; B60Q 2300/43

(57) ABSTRACT

A method for operating an electronically-controlled headlamp system of a motor vehicle capable of generating different light distributions, including a high-beam distribution and a low-beam distribution. The roadway region illuminated by the headlamps during the adjustment of the high-beam distribution comprises a high-beam region and a dimmed region, and the border between the high-beam region and the dimmed region is defined by at least one high-beam edge. An electronic headlamp controller is operable to displace or move the high-beam edge at a rate that is variable depending on a current driving scenario. The driving scenario may include a condition of a vehicle environment, a traffic scenario, a vehicle state, and an activity of vehicle driver. The transition duration between two different light intensities, the light-intensity adaptation, and the separation between a high-beam edge and an object (such as another vehicle), may also be varied depending on the driving scenario.

### CROSS-REFERENCE TO RELATED APPLICATIONS

This application claims foreign priority benefits under 35 U.S.C. §119(a)-(d) to DE 10 2015 209 419.7 filed May 22, 2015, which is hereby incorporated by reference in its entirety.

### TECHNICAL FIELD

The invention relates to a method and a device for controlling one or more headlamps of a motor vehicle.

### BACKGROUND

During the operation of a motor vehicle, it is desirable with regard to switching between different light distributions produced by the vehicle's headlamp(s) (in particular, between low beams and high beams) to offer the driver, as often and comprehensively as possible, illumination of the roadway by means of high beams while also avoiding dazzling the other road users.

DE 10 2008 014 182 A1 discloses a method for controlling the headlamps of a vehicle, wherein, depending on a position of detected objects, the high-beam light distribution is swiveled away from the region containing these objects in such a way that a space is created, which is non-dazzling for the objects, wherein the high-beam distribution is swiveled at most up to edges of the object. As a result of the automatic adjustment of the non-dazzling space, it should be possible for the driver to continuously utilize high beams without having to switch the high beams on or off manually.

In addition, there is also a need in practical applications to switch between different driving light distributions (in particular a low beam distribution and a high beam distribution) in a manner that is as steady and gradual as possible, wherein it should also be possible to switch abruptly, if necessary, for example, if oncoming traffic is suddenly encountered.

DE 10 2009 024 129 A1 discloses a method for controlling the headlamps of a vehicle, wherein a change in speed during the transition from one of the light distributions to another (in particular, from low-beam distribution to partial high-beam distribution and/or to high-beam distribution or vice versa) is adjusted in a variable manner.

With regard to the further prior art, reference is made to DE 10 2007 038 077 A1, DE 10 2011 050 535 A1, DE 10 2010 048 100 A1, DE 10 2010 035 636 A1, DE 10 2010 010 425 A1, DE 10 2010 006 296 A1, DE 10 2009 057 391 A1 and DE 10 2009 031 805 A1 merely by way of example.

It is desirable to provide a method and a device for controlling vehicle headlamps which allow for changes in the roadway illumination provided by a vehicle, in particular even within one and the same headlamp mode (e.g., with high beams on), which are perceived by the driver as being particularly steady and gradual.

### SUMMARY

In a method disclosed herein for controlling the headlamps of a vehicle, different light distributions, including a high-beam distribution and a low-beam distribution, are adjusted so that the region illuminated by the headlamps during the adjustment of the high-beam distribution comprises a high-beam region and a dimmed region, wherein the border between the high-beam region and the dimmed region is defined by at least one high-beam edge.

The method is distinguished in that the high-beam edge is at least temporarily displaced, wherein the rate of this displacement of the high-beam edge is varied depending on the scenario.

In the high-beam mode, the transition-line or border between the high-beam region and the dimmed region, referred to herein as the “high-beam edge,” is displaced at a variable rate depending on current circumstances/conditions present at the time (in particular, depending on the particular scenario that is currently present with respect to the environment, traffic, driver, or vehicle, as described in greater detail below).

In this case, the rate at which the high-beam edge is displaced need not be constant with respect to time. In principle, the high-beam edges can extend both vertically and horizontally. Moreover, the high-beam edges can also assume other shapes, e.g., elliptical shapes.

The term “dimmed” or “non-dazzling” region as used herein means the region within the regular high-beam distribution in which high-beam illumination is not applied. Without the invention being restricted thereto, the dimmed or non-dazzling region can be formed, for example, by means of a movable component in front of the reflector of the high-beam headlamp (wherein the high-beam headlamp itself can be rigidly installed).

As disclosed herein, changes in the headlamps within one and the same headlamp mode, in particular changes during a continuously activated high-beam mode, can be designed to be particularly inconspicuous and pleasant for the driver. Therefore, it is also made possible, above and beyond a gradual switch between different headlamps modes (e.g., low beams or high beams), to implement changes in the roadway illumination provided by the vehicle within one and the same lighting mode or during one and the same light distribution in a manner which is inconspicuous and non-distracting to the driver.

According to one embodiment, a crossfading (a transition over time) between two light intensities (for example, a high-beam intensity and a low-beam or “dipped” intensity) is carried out at least temporarily, wherein, furthermore, the duration of this transition is variable depending on the scenario (the one or more conditions relevant to the vehicle, its driver, and its environment) at the time the transition takes place. It is therefore possible, for example, in critical situations, to immediately completely dim or activate the high beams, whereas a slow reactivation can be carried out in other scenarios. In this case, the duration required for the transition between two light intensities is also referred to here and in the following as the transition period (or “transition duration TD”), wherein this can be, for example, the duration between the two states “no high beams” or “off” and “full high beams” or “full intensity”.

According to one embodiment, the lateral distance between one high-beam edge and an object, in particular, a foreign vehicle, is varied depending on the scenario. In embodiments, the lateral separation of the high-beam edge from the particular object (or the foreign vehicle) can therefore also be accordingly selected or varied depending on the present circumstances or scenarios. As a result, a maximum illumination close to the other road users (or foreign vehicles) can be enabled, for example, in standard scenarios, while, in other scenarios, the relevant lateral separation is increased, in order to permit, for example, a more sluggish movement of the light edge or to allow reactions to relatively dynamic scenarios (e.g., while the vehicle is travelling on a curvy road) to be carried out without abrupt or nervous movements.

According to one embodiment, the light intensity of a light distribution is varied according to the scenario. As a result, a risk of dazzling can be reduced, e.g. in scenarios in which there is an increased risk of the presence of non-discernible objects, e.g. an object on a highway that is hidden by guardrails, therefore, in situations in which potentially non-discernible objects can be present. In such scenarios, a light-intensity adaptation can be carried out, e.g. in the direction of the opposite lane, in the form of “highway high beams”, for example.

According to one embodiment, in the scenario-dependent variation, a distinction is made between different scenarios related to the environment of the vehicle. These “environmental scenarios” can include, in particular, driving on a highway, on a highway on-ramp or off-ramp, within a city, driving on curvy roads over a relatively long distance, driving within tight curves, or driving inside a tunnel or in ambient light conditions (e.g., day, night, sunset) and weather conditions (e.g., fog, rain, snow).

According to one embodiment, in the scenario-dependent variation, a distinction is made between different scenarios related to the present traffic situation. These “traffic scenarios” can include, for example, the orientation of the other road users or foreign vehicles relative to the host vehicle, the longitudinal distance between the host vehicle and the other road users, the lateral offset of the host vehicle with respect to the other road users or foreign vehicles, and the relative speed of the host vehicle with respect to the other road users or foreign vehicles.

According to one embodiment, in the scenario-dependent variation, a distinction is made between different scenarios related to the driver. These “driver scenarios” can include, for example, driving in serpentines, activation of a headlamp flasher, activation or deactivation of the system, acceleration or braking or carrying out steering motions of different intensities.

According to one embodiment, in the scenario-dependent variation, a distinction is made between different scenarios related to the present vehicle state. These relevant (to the host vehicle) “vehicle scenarios” can include, for example, the present high-beam distribution, the vehicle speed, or critical driving situations.

According to one embodiment, the high-beam edge is displaced by moving a component, which is disposed in front of a headlamp reflector and forms the dimmed region.

The invention further relates to a device for controlling the headlamps, which device is configured for carrying out a method having the above-described features. With respect to advantages and preferred embodiments of the device, reference is made to the comments presented above in connection with the method disclosed herein.

Further embodiments of the invention are found in the description and in the dependent claims.

The invention is described in greater detail in the following with reference to an exemplary embodiment depicted in the attached drawings.

### BRIEF DESCRIPTION OF THE DRAWINGS

FIG. 1 shows a schematic depiction of an exemplary scenario and a light distribution presently set by a vehicle;

FIG. 2 shows a schematic depiction of a light distribution which has been changed, as compared to FIG. 1, in a manner in accordance with a method disclosed herein; and

FIG. 3 shows a schematic depiction illustrating a distance between a high-beam edge and an object or a foreign vehicle, which is varied in accordance with a method disclosed herein.

### DETAILED DESCRIPTION

As required, detailed embodiments of the present invention are disclosed herein; however, it is to be understood that the disclosed embodiments are merely exemplary of the invention that may be embodied in various and alternative forms. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

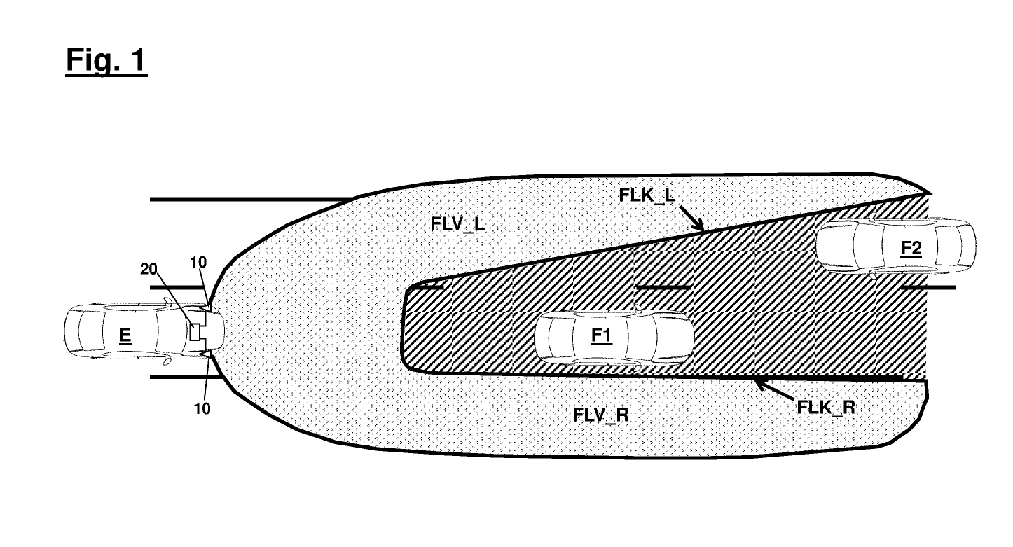

According to FIG. 1, a driving scenario is presented as a starting point, wherein a host vehicle (labeled with “E”), which is carrying out the method disclosed herein and is equipped with variable headlamps 10 and a corresponding electronic controller 20, is traveling on a two-lane roadway, wherein a first, preceding foreign vehicle F1 and a second, oncoming foreign vehicle F2 are also shown. Moreover, a light distribution presently set in the high-beam mode is indicated via the light or dotted shading, and the darker or dashed shading indicates a non-dazzling region (including, in particular, the foreign vehicles F1 and F2). The borders between the left and right edges of the high-beam distribution and the non-dazzling region are labeled in FIG. 1 with “FLK_L” and “FLK_R”, respectively, in accordance with the aforementioned definition. FLV_L and FLV_R indicate the areas of high-beam light distribution located to left and right, respectively, of the centrally-located non-dazzling region.

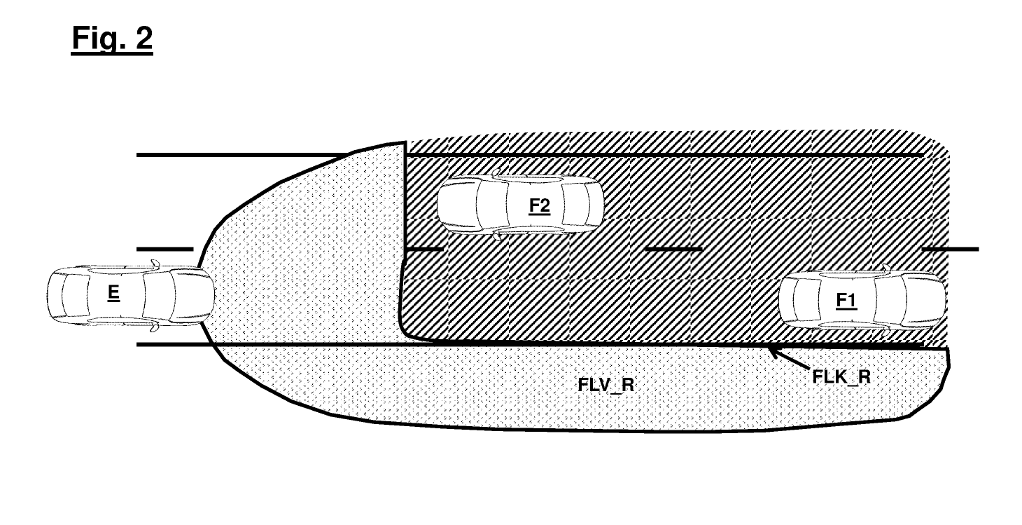

FIG. 2 shows a scenario which has occurred shortly after the scenario depicted in FIG. 1, in which the foreign vehicle F2 has come closer to the host vehicle E and is now located closer to the vehicle E than is the preceding foreign vehicle F1. In the sense of a best possible illumination of the roadway for the host vehicle driver (that is, the highest illumination of an area extending the greatest distance forward of the host vehicle E as is practicable) while simultaneously avoiding dazzling the drivers of the foreign vehicles F1 and F2, a light distribution is selected, according to FIG. 2, which is changed relative to FIG. 1, wherein the left high-beam edge has been moved here, merely by way of example, to the extent that the non-dazzling region according to FIG. 2 is delimited by high-beam edges extending nearly at right angles.

In order for changes in the roadway illumination to be as steady and gradual (and therefore visually pleasant and non-distracting when observed by the driver of the host vehicle E) as possible, the above-described change in the light distribution and/or the displacement of the high-beam edges is carried out at a rate which is variable depending on certain scenarios. All of the above-described scenarios, in particular different environmental scenarios, traffic scenarios, driver scenarios, and vehicle scenarios (related to the host vehicle), can be taken into account in this case.

Merely by way of example, the roadway depicted in FIGS. 1 and 2 can be a highway, in which case the rate of the displacement of the particular high-beam edges may be adjusted by the controller 20 to be slower than in the case of a roadway within a city, in order to avoid an unsteady displacement of the high-beam edges in this highly dynamic scenario. In addition, the separation between the high-beam edges and the transition duration and light-intensity adaptation can also be adjusted by the controller as appropriate for the described scenario. In this case, in addition, the displacement speed of the high-beam edges selected for a certain scenario (e.g., highway driving), in turn, is typically not even constant itself, and so, for example, for the traffic scenario depicted in FIG. 2 (with less longitudinal distance between the host vehicle E and the oncoming foreign vehicle F2), a displacement speed of the high-beam edge can be selected that is higher compared to the above-described traffic scenario from FIG. 1.

In the end, as a result of the displacement of the high-beam edge or the border between high beams and the dimmed region being carried out at a variable speed, the high-beam edges can be displaced as steadily and inconspicuously as possible, wherein, at the same time, the non-dazzling region can be kept as small as possible without also dazzling other road users in foreign vehicles.

In this manner, a particularly steady and gradual change in the light distribution can be achieved while simultaneously optimizing the roadway illumination for the driver and avoiding a dazzling effect.

The invention is not restricted to the sole, scenario-dependent variation of the displacement speed of the high-beam edges within the high-beam mode.

In further embodiments, alternatively or additionally, the transition duration between two different light intensities can be varied depending on the scenario that is currently present. For example, merely by way of example, the high beams can be immediately completely activated or dimmed in certain critical situations, while, in other scenarios, the high beams can be activated or dimmed relatively slowly, wherein, by contrast, the transition into a high light intensity is carried out slowly in non-critical situations, e.g., when leaving an urban area.

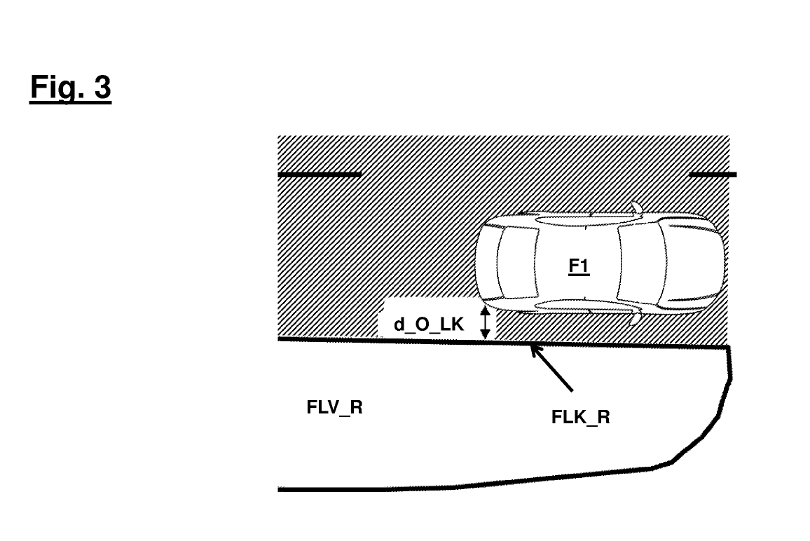

In further embodiments, the lateral distance between the high-beam edge and the object (schematically indicated and labeled d_O_LK in FIG. 3) can also be varied depending on the scenario or according to the current presence of one or more of the above-described scenarios. As a result, for example, in a standard situation, this lateral distance can be minimized so as to achieve a maximum area being subject to high-beam illumination. Said lateral distance d_O_LK can be increased in other situations, in order to allow reactions, e.g. to dynamic scenarios such as curvy roads, to be carried out without nervous movements or to allow for a more sluggish movement of the high-beam edge.

In further embodiments, a variation of the light intensity can also be carried out in a scenario-dependent manner. Specifically, the light intensity can be reduced, for example, if potentially non-discernible objects (which can be hidden by guardrails, for example, during highway driving) should be expected, depending on the scenario. This risk can be reduced in the case of highway driving, e.g. by adjusting the light intensity in the direction of the opposite lane.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of operating an electronically controlled headlamp system of a vehicle comprising:
generating a high-beam light distribution directed at a roadway on which the vehicle is travelling, the high-beam light distribution comprising a high-beam region and a dimmed region separated by a high-beam edge;
detecting a scenario comprising at least one of a condition of a vehicle environment, a traffic scenario, a vehicle state, and an activity of vehicle driver; and
operating an electronic controller to cause displacement of the high-beam edge at a rate that varies depending on the scenario.

2. The method of claim 1, further comprising operating the electronic controller to cause a transition between two light intensities created by the headlamp, a duration of the transition being variable depending on the scenario.

3. The method of claim 1, wherein a lateral distance between the high-beam edge and an object in the vehicle environment is variable depending on the scenario.

4. The method of claim 1, wherein a light intensity of the light distribution is variable depending on the scenario.

5. A method of operating a headlamp system of a vehicle comprising:
generating a light distribution comprising a high-beam region and a dimmed region separated by a high-beam edge; and
operating an electronic controller to cause displacement of the high-beam edge at a rate that varies depending on a scenario comprising at least one of a condition of a vehicle environment, a traffic scenario, a vehicle state, and an activity of vehicle driver.

6. The method of claim 5, further comprising operating the electronic controller to cause a transition between two light intensities created by the headlamp, a duration of the transition being variable depending on the scenario.

7. The method of claim 5, wherein a lateral distance between the high-beam edge and an object in the vehicle environment is variable depending on the scenario.

8. The method of claim 5, wherein a light intensity of the light distribution is variable depending on the scenario.

9. A method comprising:
operating a headlamp of a vehicle to generate a light distribution comprising a high-beam region and a dimmed region separated by a high-beam edge; and
operating an electronic controller to cause displacement of the high-beam edge at a rate that varies depending on a scenario comprising at least one of a condition of a vehicle environment, a traffic scenario, a vehicle state, and an activity of vehicle driver.

10. The method of claim 9, further comprising operating the electronic controller to cause a transition between two light intensities created by the headlamp, a duration of the transition being variable depending on the scenario.

11. The method of claim 9, wherein a lateral distance between the high-beam edge and an object in the vehicle environment is variable depending on the scenario.

12. The method of claim 9, wherein a light intensity of the light distribution is variable depending on the scenario.
